(19) United States
(12) Patent Application Publication
(10) Pub. No.: US 2020/0133073 A1
(43) Pub. Date: Apr. 30, 2020

(54) DISPLAY DEVICE

(71) Applicant: Samsung Display Co., Ltd., Yongin-Si (KR)

(72) Inventor: KYOUNGDUCK KIM, Hwaseong-si (KR)

(21) Appl. No.: 16/448,468

(22) Filed: Jun. 21, 2019

(30) Foreign Application Priority Data
Oct. 24, 2018 (KR) 10-2018-0127498

(51) Int. Cl. G02F 1/1335; G02F 1/1333

(52) U.S. Cl. CPC G02F 1/133608; G02F 1/133606; G02F 1/133308

(57) ABSTRACT

A display device includes a display panel, a diffusion plate disposed under the display panel, a light source disposed under the diffusion plate, and a first accommodating portion. The light source and the diffusion plate are each disposed on the first accommodating portion. The display device further includes a support portion coupled to the first accommodating portion to support the diffusion plate. The support portion includes a columnar portion, a coupling portion connected to a lower end of the columnar portion and coupled to the first accommodating portion, and a plurality of buffer portions connected to portions of the columnar portion and having a convex curved shape protruding downward. The portions of the columnar portion are disposed between an upper end of the columnar portion and the lower end of the columnar portion.

### CROSS-REFERENCE TO RELATED APPLICATION

This U.S. non-provisional patent application claims priority under 35 U.S.C. § 119 to Korean Patent Application No. 10-2018-0127498, filed on Oct. 24, 2018, the disclosure of which is incorporated by reference herein in its entirety.

### TECHNICAL FIELD

The present inventive concept relates to a display device, and more particularly, to a display device including support portions.

### DISCUSSION OF THE RELATED ART

In general, a liquid crystal display device may include a non-light emitting display panel, such as a liquid crystal display panel, and a backlight unit for providing light to the display panel. The backlight unit generates light and provides the generated light to the display panel, and the display panel displays images by using the light received from the backlight unit.

An edge-type backlight unit or a direct-type backlight unit may be used as the backlight unit. The direct-type backlight unit is disposed under the display panel to provide light to the display panel. The direct-type backlight unit includes an optical member, a diffusion plate disposed under the optical member, and a light source disposed under the diffusion plate. The light generated by the light source is diffused by the diffusion plate and provided to the optical member. The optical member increases luminance uniformity of the light and provides the light to the display panel.

The light source is spaced apart from the diffusion plate. The edge of the diffusion plate is disposed on a bottom chassis. When the liquid crystal display device receives an external impact, the impact may transfer to the diffusion plate, and thus, the diffusion plate may be damaged.

### SUMMARY

According to an exemplary embodiment of the present inventive concept, a display device includes: a display panel extending along a first direction and a second direction crossing the first direction; a diffusion plate disposed under the display panel; a light source disposed under the diffusion plate; a first accommodating portion, wherein the light source and the diffusion plate are each disposed on the first accommodating portion; and a support portion coupled to the first accommodating portion to support the diffusion plate. The support portion includes: a columnar portion extending in a third direction perpendicular to the first and second directions; a coupling portion connected to a lower end of the columnar portion and coupled to the first accommodating portion; and a plurality of buffer portions connected to portions of the columnar portion and having a convex curved shape protruding downward. The portions of the columnar portion are disposed between an upper end of the columnar portion and the lower end of the columnar portion.

In an exemplary embodiment of the present inventive concept, the lower end of the columnar portion is inserted into a first hole provided in the first accommodating portion.

In an exemplary embodiment of the present inventive concept, the coupling portion passes through the first hole to be disposed under the first accommodating portion around the first hole.

In an exemplary embodiment of the present inventive concept, the coupling portion includes at least two hooks extending in different directions from each other.

In an exemplary embodiment of the present inventive concept, the coupling portion includes: a vertical extending portion connected to the lower end of the columnar portion and extending in the third direction; and a plurality of hooks extending from a lower end of the vertical extending portion. Each of the plurality of hooks forms an angle smaller than about 90° with the vertical extending portion and extends upward, and upper ends of the plurality of hooks are disposed under the first accommodating portion around the first hole.

In an exemplary embodiment of the present inventive concept, the light source includes: a plurality of light source substrates disposed on a plurality of grooves provided in the first accommodating portion; and a plurality of light source units respectively mounted on the plurality of light source substrates.

In an exemplary embodiment of the present inventive concept, the display device further includes a plurality of first holes including the first hole, and a plurality of support portions including the support portion. The plurality of first holes and the plurality of support portions are disposed between pairs of light source substrates of the plurality of light source substrates.

In an exemplary embodiment of the present inventive concept, the display device further includes a reflective sheet disposed on the plurality of light source substrates and having insertion holes provided therein, the insertion holes having the plurality of light source units inserted thereinto. The lower end of the columnar portion is inserted into a second hole provided in the reflective sheet such that the second hole overlays the first hole.

In an exemplary embodiment of the present inventive concept, the coupling portion passes through the second hole and the first hole and is disposed under the first accommodating portion.

In an exemplary embodiment of the present inventive concept, the upper end of the columnar portion is in contact with the diffusion plate, and lower ends of the plurality of buffer portions are in contact with the reflective sheet.

In an exemplary embodiment of the present inventive concept, the plurality of buffer portions are closer to the lower end of the columnar portion than to the upper end of the columnar portion.

In an exemplary embodiment of the present inventive concept, the columnar portion, the coupling portion, and the plurality of buffer portions are formed together as a single body.

In an exemplary embodiment of the present inventive concept, the support portion includes a plastic material having a predetermined elasticity.

In an exemplary embodiment of the present inventive concept, the display device further includes an optical sheet disposed between the display panel and the diffusion plate.

In an exemplary embodiment of the present inventive concept, the plurality of buffer portions include: a first buffer portion; and a second buffer portion forming an angle of 180° with the first buffer portion with respect to the columnar portion and having a shape symmetrical to that of the first buffer portion with respect to the columnar portion.

In an exemplary embodiment of the present inventive concept, the plurality of buffer portions include: a first buffer portion; a second buffer portion forming an angle of about 120° with the first buffer portion with respect to the columnar portion; and a third buffer portion forming an angle of about 120° with each of the first buffer portion and the second buffer portion with respect to the columnar portion.

In an exemplary embodiment of the present inventive concept, the plurality of buffer portions include: a first buffer portion; a second buffer portion forming an angle of about 1800 with the first buffer portion with respect to the columnar portion; a third buffer portion forming an angle of about 90° with the first buffer portion with respect to the columnar portion; and a fourth buffer portion forming an angle of about 180° with the third buffer portion with respect to the columnar portion.

According to an exemplary embodiment of the present inventive concept, a display device includes: a display panel extending in a first direction and a second direction crossing the first direction; a diffusion plate disposed under the display panel; a light source disposed under the diffusion plate; a first accommodating portion, wherein the light source and the diffusion plate are disposed on the first accommodating portion; and a support portion coupled to the first accommodating portion to support the diffusion plate. The support portion includes: a columnar portion extending in a third direction perpendicular to the first and second directions; a coupling portion connected to a lower end of the columnar portion and coupled to the first accommodating portion; and a plurality of buffer portions connected to portions of the columnar portion. The portions of the columnar portion are disposed between an upper end of the columnar portion and the lower end of the columnar portion. Each of the plurality of buffer portions forms an angle smaller than about 90° with the columnar portion, extends downward, and is substantially straight.

According to an exemplary embodiment of the present inventive concept, a display device includes: a display panel; a diffusion plate disposed under the display panel; a light source disposed under the diffusion plate; a first accommodating portion, wherein the light source and the diffusion plate are disposed on the first accommodating portion; and a support portion coupled to the first accommodating portion to support the diffusion plate. The support portion includes: a columnar portion extending in a direction crossing the display panel; a plurality of buffer portions connected to portions of the columnar portion and having a convex curved shape protruding downward, wherein the portions of the columnar portion are adjacent to a lower end of the columnar portion; a subsupport portion connected to a lower end of a first buffer portion of the plurality of buffer portions; an insertion portion connected to a lower portion of the subsupport portion and inserted into a first hole provided in the first accommodating portion; and a coupling portion connected to a lower portion of the insertion portion and disposed on a lower portion of the first accommodating portion around the first hole.

In an exemplary embodiment of the present inventive concept, the subsupport portion is larger than the first hole, an upper end of the columnar portion is in contact with the diffusion plate, and the lower end of the columnar portion is spaced apart from a bottom portion of the first accommodating portion.

### BRIEF DESCRIPTION OF THE DRAWINGS

The above and other features of the present inventive concept will become more apparent by describing in detail exemplary embodiments thereof, with reference to the accompanying drawings, in which:

FIG. 1 is an exploded perspective view of a display device according to an exemplary embodiment of the present inventive concept;

FIG. 2 is a view showing a configuration of one pixel of a display panel illustrated in FIG. 1 according to an exemplary embodiment of the present inventive concept;

FIG. 3 is a cross-sectional view taken along line I-I′ of FIG. 1 according to an exemplary embodiment of the present inventive concept;

FIG. 4 is a view illustrating a configuration of a support portion illustrated in FIG. 1 according to an exemplary embodiment of the present inventive concept;

FIG. 5 is a top view of the support portion illustrated in FIG. 4 according to an exemplary embodiment of the present inventive concept;

FIGS. 6, 7 and 8 illustrate a method for coupling, to a first accommodating portion, the support portion illustrated in FIG. 4 according to an exemplary embodiment of the present inventive concept;

FIG. 9 is a cross-sectional view taken along line II-II′ of FIG. 1 according to an exemplary embodiment of the present inventive concept;

FIG. 10 is a view illustrating a configuration of a support portion of a display device according to an exemplary embodiment of the preset inventive concept;

FIG. 11 is a view illustrating a configuration of a support portion of a display device according to an exemplary embodiment of the present inventive concept;

FIG. 12 is a view illustrating a configuration of a support portion of a display device according to an exemplary embodiment of the present inventive concept; and

FIG. 13 is a view illustrating a configuration of a support portion of a display device according to an exemplary embodiment of the present inventive concept.

### DETAILED DESCRIPTION OF THE EMBODIMENTS

Exemplary embodiments of the present inventive concept will now be described more fully with reference to the accompanying drawings. It is to be understood that the present inventive concept may be embodied in different forms and thus should not be construed as being limited to the exemplary embodiments set forth herein.

When an element (e.g., a region, a layer, or a portion) is referred to as being “on,” “connected to,” or “coupled to” another element, it may be directly on, connected to, or coupled to the other element, or intervening elements may be present therebetween.

In the figures, like reference numerals may denote like elements, and thus their descriptions may be omitted. Further, in the drawings, the thicknesses, proportions, and dimensions of elements may be exaggerated for clarity.

It will be understood that although the terms “first” and “second” may be used herein to describe various elements, these elements should not be limited by the terms. The terms are only used to distinguish one element from another element. For example, a first element could be termed a second element, and, similarly, a second element could be termed the first element without departing from the spirit and scope of the present inventive concept.

Also, spatially relative terms, such as “beneath”, “below”, “lower”, “under,” “above,” “upper,” and the like are used herein for explaining the relationship between one or more elements illustrated in the drawings. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, in the example, terms “below” and “beneath” may encompass both an orientation of above, below and beneath. The device may be otherwise oriented (e.g., rotated 90 degrees or at other orientations) and the spatially relative descriptors used herein may be interpreted accordingly.

Hereinafter, exemplary embodiments of the present inventive concept will be described in detail with reference to the accompanying drawings.

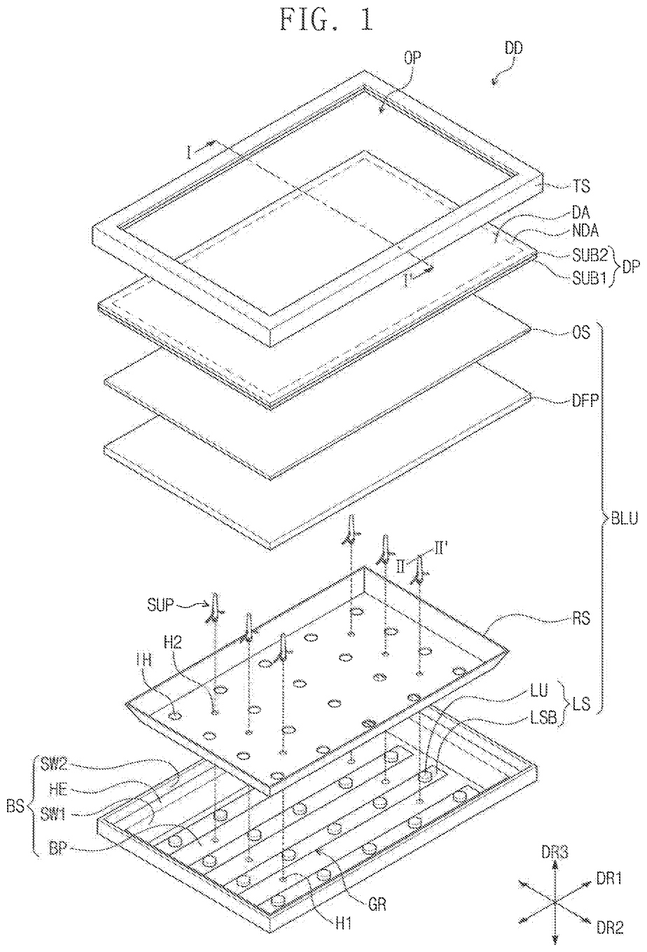

FIG. 1 is an exploded perspective view of a display device according to an exemplary embodiment of the present inventive concept.

Referring to FIG. 1, a display device DD according to an exemplary embodiment of the present inventive concept may include a display panel DP, a backlight unit BLU, and first and second accommodating portions BS and TS. Various display panels, such as a liquid crystal display panel, an electrophoretic display panel, and an electrowetting display panel, capable of displaying images can be used as the display panel DP. In the present embodiment, the display panel DP may be a liquid crystal display panel, as an example.

The display panel DP may have a plane extending in a first direction DR1 and a second direction DR2 crossing the first direction DR1. The display panel DP may have a rectangular shape having long sides in the first direction DR1 and short sides in the second direction DR2. However, the shape of the display panel DP is not limited thereto.

A direction, crossing substantially perpendicular to the plane defined by the first and second directions DR1 and DR2, is hereinafter defined as a third direction DR3.

The display panel DP may include a first substrate SUB1, a second substrate SUB2 disposed to face the first substrate SUB1, and a liquid crystal layer disposed between the first substrate SUB1 and the second substrate SUB2. Liquid crystal molecules of the liquid crystal layer may adjust transmittance of light to display images.

The plane of the display panel DP may include a display area DA and a non-display area NDA at least partially surrounding the display area DA. A plurality of pixels for displaying images may be disposed in the display area DA. The non-display area NDA does not display images, and driving units for driving the pixels may be disposed in the non-display area NDA.

The backlight unit BLU may be disposed under the display panel DP to provide light to the display panel DP. The pixels of the display panel DP may display images by using the light received from the backlight unit BLU. The first and second accommodating portions BS and TS may accommodate and protect the backlight unit BLU and the display panel DP.

The backlight unit BLU may include an optical sheet OS, a diffusion plate DFP, a light source LS, a reflective sheet RS, and a plurality of support portions SUP. The optical sheet OS may be disposed on the display panel DP, and the diffusion plate DFP may be disposed on the optical sheet OS. For example, the optical sheet OS may be disposed under the display panel DP, and the diffusion plate DFP may be disposed under the optical sheet OS. The light source LS and the reflective sheet RS may be disposed on the diffusion plate DFP. For example, the light source LS and the reflective sheet RS may be disposed under the diffusion plate DFP. The support portions SUP may be disposed on the diffusion plate DFP to support the diffusion plate DFP. For example, the support portions SUP may be disposed under the diffusion plate DFP.

Light generated by the light source LS may be provided to the diffusion plate DFP. The diffusion plate DFP may diffuse the light received from the light source LS. The diffusion plate DFP may be a structure harder than the optical sheet OS. A diffusing agent may be distributed in the diffusion plate DFP, or a surface of the diffusion plate DFP may be coated with a diffusing agent film. The light diffused by the diffusion plate DFP may be provided to the optical sheet OS.

The optical sheet OS may concentrate the light diffused by the diffusion plate DFP and provide the concentrated light to the display panel DP. The optical sheet OS may include a diffusion sheet, a prism sheet disposed on the diffusion sheet, and a protective sheet disposed on the prism sheet.

The diffusion sheet may serve to diffuse the light received from the diffusion plate DFP. The prism sheet may serve to concentrate, in the third direction DR3, the light diffused by the diffusion sheet. The light passing through the prism sheet may vertically travel in an upward direction. As a result, the light having a uniform luminance distribution may be provided to the display panel DP. The protective sheet may protect the prism sheet from scratches.

The light source LS may be disposed under the reflective sheet RS. The light source LS may include a plurality of light source substrates LSB and a plurality of light source units LU mounted on each of the light source substrates LSB. For example, the light source units LU may be mounted on upper surfaces of the light source substrates LSB. However, the present inventive concept is not limited thereto.

The light source substrates LSB may have rectangular shapes having long sides extended in the first direction DR1 and short sides extended in the second direction DR2. However, the present inventive concept is not limited thereto, and the light source substrates LSB may have square shapes or another polygonal shape. The light source substrates LSB may be disposed on a plurality of grooves GR formed in the first accommodating portion BS to extend in the first direction DR1.

The light source units LU mounted on the same light source substrate LSB may be arranged in the first direction DR1 and spaced apart from each other at predetermined intervals. For example, the predetermined intervals may be substantially equal to one another. Each of the light source units LU may include a light-emitting diode. Light generated by the light source units LU may be provided to the diffusion plate DFP.

A plurality of insertion holes IH overlaying the light source units LU may be formed in the reflective sheet RS. For example, the insertion holes IH may have circular shapes. The reflective sheet RS may be disposed on the light source substrates LSB, and the light source units LU may be inserted into the insertion holes IH. The reflective sheet RS may serve to reflect light emitted laterally and in a direction opposite the third direction DR3 from the light source units LU and provide the reflected light to the diffusion plate DFP.

The first accommodating portion BS may be a bottom chassis. The first accommodating portion BS may accommodate the backlight unit BLU. The first accommodating portion BS may include a bottom portion BP, a first side wall portion SW1, a horizontal extending portion HE, and a second side wall portion SW2. The bottom portion BP may have a plane parallel to the first and second directions DR1 and DR2. The bottom portion BP may have a rectangular shape having long sides in the first direction DR1 and short sides in the second direction DR2. However, the present inventive concept is not limited thereto.

The grooves GR for disposing the light source substrates LSB may be formed in the bottom portion BP. A plurality of first holes H1 may be formed in the bottom portion BP. The first holes H1 may be disposed between the light source substrates LSB. A plurality of second holes H2 overlaying the first holes H1 may be formed in the reflective sheet RS. For example, the first and second holes H1 and H2 may have circular shapes.

The first side wall portion SW1 may extend upward from a boundary of the bottom portion BP. For example, a lower end of the first side wall portion SW1 may be connected to the bottom portion BP. The first side wall portion SW1 may have an inclined surface forming a predetermined angle with the bottom portion BP and may extend in an upward direction with respect to the bottom portion BP. The horizontal extending portion HE may extend parallel to the bottom portion BP and from an upper end of the first side wall portion SW1. For example, the horizontal extending portion HE may be disposed at a level different from that of the bottom portion BP. The second side wall portion SW2 may extend upward vertically from a boundary of the horizontal extending portion HE. For example, the second side wall portion SW2 may be substantially perpendicular to the horizontal extending portion HE.

The support portions SUP may be coupled to the first accommodating portion BS to support the diffusion plate DFP. For example, the support portions SUP may be inserted into the first holes H1 and the second holes H2 to be coupled to the bottom portion BP. The support portions SUP may extend in the third direction DR3 to be disposed under the diffusion plate DFP. For example, six support portions SUP are illustrated. However, the number of support portions SUP is not limited thereto.

The second accommodating portion TS may be a top chassis and disposed on the display panel DP. The second accommodating portion TS may have a frame shape. An opening portion OP for exposing the display area DA may be formed in the second accommodating portion TS.

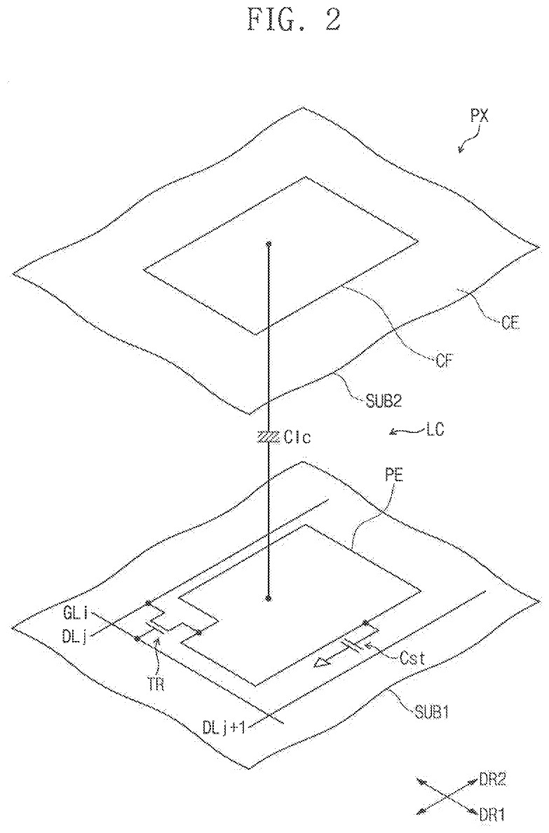

FIG. 2 is a view showing a configuration of one pixel of a display panel illustrated in FIG. 1 according to an exemplary embodiment of the present inventive concept.

Referring to FIG. 2, a pixel PX may include a transistor TR connected to a gate line GLi and a data line DLj (where i and j are positive integers), a liquid crystal capacitor Clc connected to the transistor TR, and a storage capacitor Cst connected in parallel to the liquid crystal capacitor Clc. The storage capacitor Cst may be omitted.

The transistor TR may be disposed on the first substrate SUB1. The transistor TR may include a gate electrode connected to the gate line GLi, a source electrode connected to the data line DLj, and a drain electrode connected to the liquid crystal capacitor Clc and the storage capacitor Cst.

The liquid crystal capacitor Clc may include a pixel electrode PE disposed on the first substrate SUB1, a common electrode CE disposed on the second substrate SUB2, and a liquid crystal layer LC disposed between the pixel electrode PE and the common electrode CE. The liquid crystal layer LC may serve as a dielectric. The pixel electrode PE may be connected to the drain electrode of the transistor TR.

The pixel electrode PE of FIG. 2 has a non-slit structure. However, a structure of the pixel electrode PE is not limited thereto. For example, the pixel electrode PE may have a slit structure that includes a stem portion having a cruciform shape and a plurality of branch portions extending radially from the stem portion.

The common electrode CE may be disposed under the second substrate SUB2. For example, the common electrode CE may be entirely disposed under the second substrate SUB2. However, the position of the common electrode CE is not limited thereto. For example, the common electrode CE may be disposed on the first substrate SUB1. In this case, at least one of the pixel electrode PE and the common electrode CE may include a slit.

The storage capacitor Cst may include the pixel electrode PE, a storage electrode branched from a storage line, and an insulating layer disposed between the pixel electrode PE and the storage electrode. The storage line may be disposed on the first substrate SUB1 and simultaneously formed with gate lines GLi on the same layer. The storage electrode may partially overlap the pixel electrode PE.

The pixel PX may further include a color filter CF corresponding to a red, a green, or a blue color. According to an exemplary embodiment of the present inventive concept, the color filter CF may be disposed on the second substrate SUB2 as illustrated in FIG. 2. However, the position of the color filter CF is not limited thereto. The color filter CF may be disposed on the first substrate SUB1.

The transistor TR may be turned on in response to a gate signal received through the gate line GLi. A data voltage received through the data line DLj may be provided to the pixel electrode PE of the liquid crystal capacitor Clc through the transistor TR that is turned on. A common voltage may be applied to the common electrode CE.

A difference in voltage level between the data voltage and the common voltage may allow an electric field to be formed between the pixel electrode PE and the common electrode CE. The electric field formed between the pixel electrode PE and the common electrode CE may drive liquid crystal molecules of the liquid crystal layer LC. The liquid crystal molecules driven by the electric field may allow light transmittance to be adjusted so that images may be displayed.

A storage voltage having a certain voltage level may be applied to the storage line. However, the present inventive concept is not limited thereto. For example, the common voltage may be applied to the storage line. The storage capacitor Cst may serve to compensate for an amount of charges charged in the liquid crystal capacitor Clc.

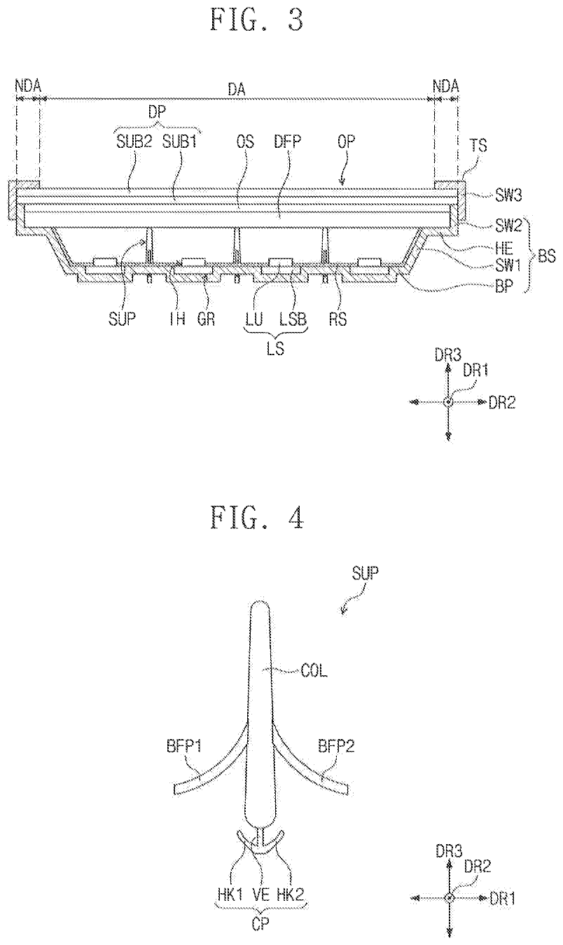

FIG. 3 is a cross-sectional view taken along line I-I′ of FIG. 1 according to an exemplary embodiment of the present inventive concept.

Referring to FIG. 3, the light source LS, the reflective sheet RS, the diffusion plate DFP, and the optical sheet OS may be accommodated in the first accommodating portion BS. The light source substrates LSB may be inserted into the grooves GR formed in the bottom portion BP. For example, a thickness of each of the light source substrates LSB may be equal to a depth of each of the grooves GR in the third direction DR3. However, the present inventive concept is not limited thereto, and the light source substrates LSB may protrude from the grooves GR.

The reflective sheet RS may be disposed on the bottom portion BP. The light source units LU may be inserted into the insertion holes IH of the reflective sheet RS, and the reflective sheet RS may be disposed on the light source substrates LSB. The reflective sheet RS may also be disposed on the first side wall portion SW1.

The diffusion plate DFP may be disposed on the reflective sheet RS, and an edge of the diffusion plate DFP may be disposed on the horizontal extending portion HE. Since the edge of the diffusion plate DFP may be disposed on the horizontal extending portion HE, a predetermined space may be provided between the diffusion plate DFP and the bottom portion BP. Thus, the light source units LU may be spaced apart from the diffusion plate DFP.

The optical sheet OS may be disposed between the diffusion plate DFP and the display panel DP. The diffuser plate DFP may have a rigid structure, and the optical sheet OS may, however, be relatively thin and have a bending property. The diffusion plate DFP may support the optical sheet OS such that the optical sheet OS may be substantially flat.

For example, Lateral surfaces of the diffusion plate DFP and the optical sheet OS may be disposed adjacent to an inner surface of the second side wall portion SW2. The optical sheet OS may be disposed such that a height of an upper surface of the optical sheet OS is the same as that of an upper surface of the second side wall portion SW2. The optical sheet OS and the second side wall portion SW2 may have the display panel DP disposed thereon.

The second accommodating portion TS may be disposed to cover the non-display area NDA. The opening portion OP may expose the display area DA. The second accommodating portion TS may include a third side wall portion SW3 extending in the third direction DR3 to be disposed adjacent to an outer surface of the second side wall portion SW2.

The support portions SUP may be coupled to the bottom portion BP and may extend in the third direction DR3 to be disposed under the diffusion plate DFP. The support portions SUP may be disposed between the light source substrates LSB. For example, the support portions SUP may include a plastic material having a predetermined elastic force. For example, the support portions SUP may have a predetermined elasticity or modulus of elasticity. The support portions SUP may support the diffusion plate DFP and absorb an impact applied to the diffusion plate DFP. Such a configuration will hereinafter be detailed.

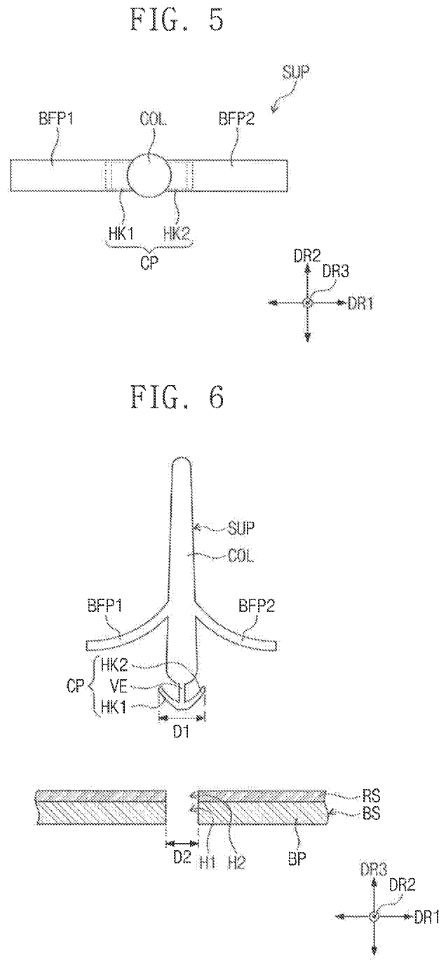

FIG. 4 is a view illustrating a configuration of a support portion illustrated in FIG. 1 according to an exemplary embodiment of the present inventive concept. FIG. 5 is a top view of the support portion illustrated in FIG. 4 according to an exemplary embodiment of the present inventive concept.

For example, FIG. 4 illustrates one support portion SUP, and, however, the other support portions SUP illustrated in FIG. 1 have the same configuration as the support portion SUP illustrated in FIG. 4. FIG. 4 illustrates a side of the support portion SUP viewed in the second direction DR2, and FIG. 5 illustrates a coupling portion CP with dotted lines.

Referring to FIGS. 4 and 5, the support portion SUP may include a columnar portion COL, the coupling portion CP, and a plurality of buffer portions BFP1 and BFP2. The columnar portion COL may extend in the third direction DR3 and have, for example, a cylindrical shape. However, the present inventive concept is not limited thereto. For example, the columnar portion COL may have a polygonal shape.

The coupling portion CP may be connected to a lower end of the columnar portion COL. For example, the coupling portion CP may have an anchor shape. The coupling portion CP may include a vertical extending portion VE connected to the lower end of the columnar portion COL and extends in the third direction DR3. The coupling portion CP may further include a plurality of hooks HK1 and HK2 extending from a lower end of the vertical extending portion VE. The hooks HK1 and HK2 may each form an angle smaller than about 90° with the vertical extending portion VE and extend upward.

The hooks HK1 and HK2 may include a first hook HK1 and a second hook HK2 having a shape symmetrical to that of the first hook HK1 with respect to the vertical extending portion VE. The first hook HK1 and the second hook HK2 may be disposed to face each other in the first direction DR1. When viewed in a plane, the first hook HK1 and the second hook HK2 may form an angle of 180° with each other with respect to the columnar portion COL.

The buffer portions BFP1 and BFP2 may be connected to predetermined portions of the columnar portion COL between an upper end of the columnar portion COL and the lower end of the columnar portion COL. The buffer portions BFP1 and BFP2 may be closer to the lower end of the columnar portion COL than to the upper end of the columnar portion COL. The buffer portions BFP1 and BFP2 may have downwardly convex curved shapes. For example, the buffer portions BFP1 and BFP2 may have a convex curved shape that protrudes downward, and the buffer portions BFP1 and BFP2 may extend away from the columnar portion COL.

The buffer portions BFP1 and BFP2 may include a first buffer portion BFP1 and a second buffer portion BFP2 having a shape symmetrical to that of the first buffer portion BFP1 with respect to the columnar portion COL. The first buffer portion BFP1 and the second buffer portion BFP2 may be disposed to face each other in the first direction DR1. When viewed in a plane, the first buffer portion BFP1 and the second buffer portion BFP2 may form an angle of 180° with each other with respect to the columnar portion COL.

In an exemplary embodiment of the present inventive concept, the columnar portion COL, the coupling portion CP, and the first and second buffer portions BFP1 and BFP2 may be integrally formed. For example, the columnar portion COL, the coupling portion CP, and the first and second buffer portions BFP1 and BFP2 may be a single body and not multiple bodies connected to each other. However, a method for forming the columnar portion COL, the coupling portion CP, and the first and second buffer portions BFP1 and BFP2 is not limited thereto. The columnar portion COL, the coupling portion CP, and the first and second buffer portions BFP1 and BFP2 may also be individually manufactured and connected to each other.

FIGS. 6, 7 and 8 illustrate a method for coupling, to a first accommodating portion, the support portion illustrated in FIG. 4 according to an exemplary embodiment of the present inventive concept.

For convenience in explanation, FIGS. 6, 7 and 8 illustrate a cross section of the support portion SUP, a cross section of the bottom portion BP in which the first holes H1 are formed, and a cross section of the reflective sheet RS in which the second holes H2 are formed, which are viewed in the second direction DR2.

Referring to FIG. 6, the support portion SUP may be disposed on the reflective sheet RS. A first distance D1 between a left end of the first hook HK1 and a right end of the second hook HK2 may be greater than a second distance D2, which is a diameter of each of the first and second holes H1 and H2.

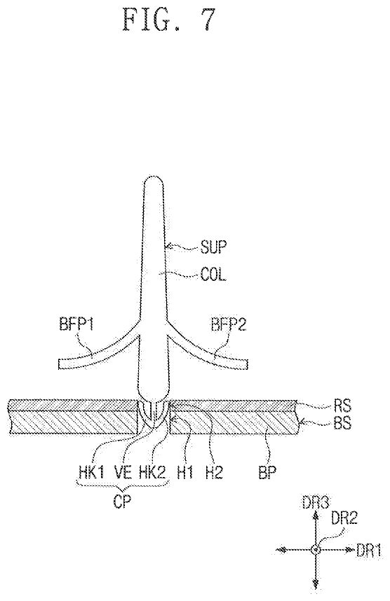

Referring to FIG. 7, the coupling portion CP may be moved downward to be inserted into the second hole H2 and the first hole H1. Since the coupling portion CP has a predetermined elasticity, the shape of the coupling portion CP may be deformed such that the vertical extending portion VE may pass through the first and second holes H1 and H2. For example, as the vertical extending portion VE passes through the first and second holes H1 and H2 and the coupling portion CP is deformed, the vertical extending portion VE may be adjacent to sidewalls of the first and second holes H1 and H2. Thus, the coupling portion CP may easily pass through the second hole H2 and the first hole H1.

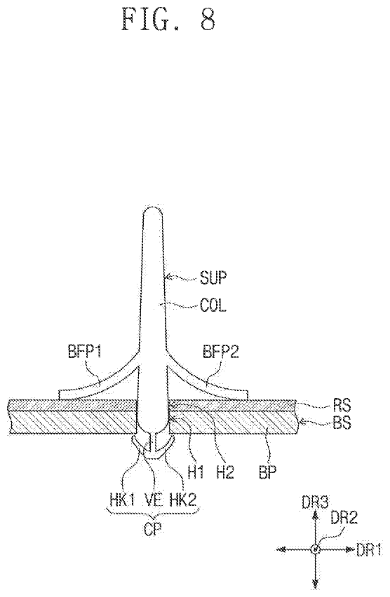

Referring to FIG. 8, the coupling portion CP may pass through the second hole H2 and the first hole H1 to be disposed under the bottom portion BP. A lower portion of the columnar portion COL may be inserted into the first and second holes H1 and H2 to be disposed within the first and second holes H1 and H2. Thus, the support portion SUP may be coupled to the first accommodating portion BS.

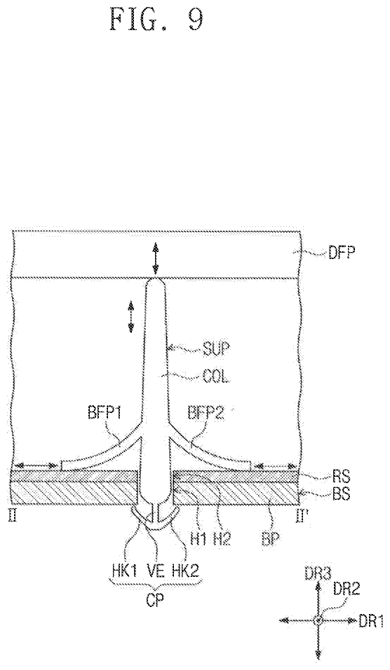

FIG. 9 is a cross-sectional view taken along line II-II′ of FIG. 1 according to an exemplary embodiment of the present inventive concept.

FIG. 9 illustrates the diffusion plate DFP, the bottom portion BP, and the reflective sheet RS together with the support portion SUP.

Referring to FIG. 9, the coupling portion CP may be disposed under the bottom portion BP around the first hole H1. For example, upper ends of the hooks HK1 and HK2 may be disposed under the bottom portion BP around the first hole H1.

The lower portion of the columnar portion COL may be disposed within the first and second holes H1 and H2, and the upper end of the columnar portion COL may be in contact with the diffusion plate DFP. The columnar portion COL may support the diffusion plate DFP. Lower ends of the first and second buffer portions BFP1 and BFP2 may be in contact with the reflective sheet RS.

When an external impact is applied to the diffusion plate DFP, the diffusion plate DFP may be moved vertically. In this case, the lower ends of the first and second buffer portions BFP1 and BFP2 may be moved horizontally, and the columnar portion COL may be moved vertically to absorb the applied impact. The lower portion of the columnar portion COL may be vertically moved along the first and second holes H1 and H2. Such a buffering action of the support portion SUP may allow the impact applied to the diffusion plate DFP to be absorbed.

The columnar portion COL may move upward along the first and second holes H1 and H2 after absorbing the impact applied to the diffusion plate DFP due to the elasticity of the first and second buffering portions BFP1 and BFP2. In this case, while the upper ends of the first and second hooks HK1 and HK2 come in contact with the bottom portion BP around the first hole H1, the columnar portion COL may be prevented from being moved upward any more.

When a support portion that does not effect a buffering action supports the diffusion plate DFP, an external impact applied to the diffusion plate DFP may be transmitted to the diffusion plate DFP without being absorbed by the support portion. Thus, the impact may be concentrated on a portion of the diffusion plate DFP, being in contact with the support portion, so that the diffusion plate DFP may be damaged.

However, in an exemplary embodiment of the present inventive concept, the support portions SUP may support the diffusion plate DFP, and buffering actions of the first and second buffer portions BFP1 and BFP2 may allow the impact applied to the diffusion plate DFP to be absorbed. Thus, the diffusion plate DFP may be prevented from being damaged.

As a result, the display device DD, according to an exemplary embodiment of the present inventive concept, may prevent damage to the diffusion plate DFP due to an external impact.

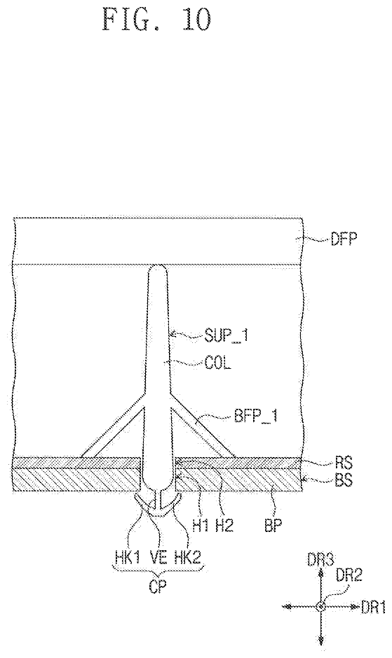

FIG. 10 is a view illustrating a configuration of a support portion of a display device according to an exemplary embodiment of the present inventive concept.

FIG. 10 illustrates a side view corresponding to FIG. 4. Hereinafter, a configuration of a support portion SUP_1 will be described mainly with regard to differences from the configuration of the support portion SUP illustrated in FIG. 4. Further, the same configuration as the support portion SUP is illustrated by using the same reference signs, and a description of the same configuration may be omitted.

Referring to FIG. 10, the support portion SUP_1 may include a columnar portion COL, a coupling portion CP, and a plurality of buffer portions BFP_1. The columnar portion COL and the coupling portion CP may be the same as the columnar portion COL and the coupling portion CP of the support portion SUP illustrated in FIG. 4.

The buffer portions BFP_1 may each form an angle smaller than about 90° with the columnar portion COL and extend downward. The buffer portions BFP_1 may extend to have linear shapes unlike the buffer portions BFP1 and BFP2 illustrated in FIG. 4. For example, the buffer portions BFP_1 may be substantially straight and may lack a curve. Similar to the buffer portions BFP1 and BFP2, the buffer portions BFP_1 having a predetermined elasticity may effect a buffering action.

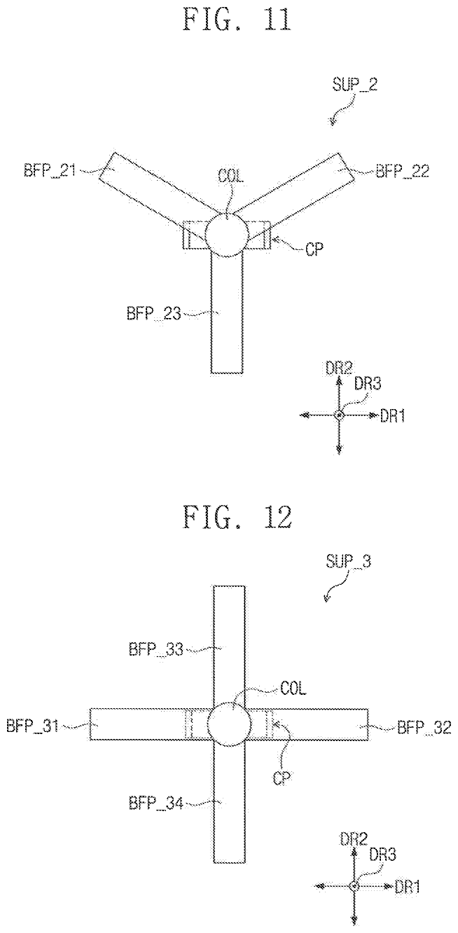

FIG. 11 is a view illustrating a configuration of a support portion of a display device according to an exemplary embodiment of the present inventive concept.

FIG. 11 is a plan view corresponding to FIG. 5 and illustrates a support portion SUP_2 viewed from above.

Hereinafter, a configuration of the support portion SUP_2 will be described mainly with regard to differences from the configurations of the support portion SUP illustrated in FIG. 4. Further, the same configuration as the support portion SUP is illustrated by using the same reference signs, and a description of the same configuration may be omitted.

Referring to FIG. 11, the support portion SUP_2 may include a columnar portion COL, a coupling portion CP, and a plurality of buffer portions BFP_21, BFP_22, and BFP_23. The columnar portion COL and the coupling portion CP may be the same as the columnar portion COL and the coupling portion CP of the support portion SUP illustrated in FIG. 4. The buffer portions BFP_21, BFP_22, and BFP_23 may be provided as three buffer portions unlike the two buffer portions BFP1 and BFP2 illustrated in FIG. 4.

The buffer portions BFP_21, BFP_22, and BFP_23 may include a first buffer portion BFP_21, a second buffer portion BFP_22, and a third buffer portion BFP_23. The second buffer portion BFP_22 may form an angle of about 120° with the first buffer portion BFP_21 with respect to the columnar portion COL. The third buffer portion BFP_23 may form an angle of about 120° with each of the first buffer portion BFP_21 and the second buffer portion BFP_22 with respect to the columnar portion COL.

Although not illustrated, the first, second, and third buffer portions BFP_21, BFP_22, and BFP_23 may have downwardly convex curved shapes similar to the buffer portions BFP1 and BFP2 illustrated in FIG. 4.

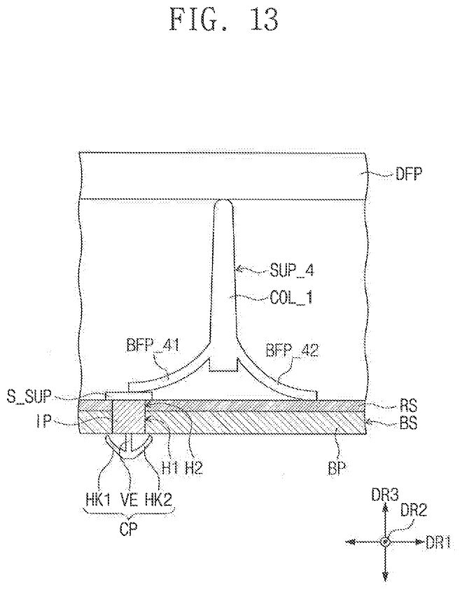

FIG. 12 is a view illustrating a configuration of a support portion of a display device according to an exemplary embodiment of the present inventive concept.

FIG. 12 is a plan view corresponding to FIG. 5 and illustrates a support portion SUP_3 viewed from above.

Hereinafter, a configuration of the support portion SUP_3 will be described mainly with regard to differences from the configurations of the support portion SUP illustrated in FIG. 4. Further, the same configuration as the support portion SUP is illustrated by using the same reference signs, and a description of the same configuration may be omitted.

Referring to FIG. 12, the support portion SUP_3 may include a columnar portion COL, a coupling portion CP, and a plurality of buffer portions BFP_31, BFP_32, BFP_33, and BFP_34. The columnar portion COL and the coupling portion CP may be the same as the columnar portion COL and the coupling portion CP of the support portion SUP illustrated in FIG. 4. The buffer portions BFP_31, BFP_32, BFP_33, and BFP_34 may be provided as four buffer portions unlike the two buffer portions BFP1 and BFP2 illustrated in FIG. 4.

The buffer portions BFP_31, BFP_32, BFP_33, and BFP_34 may include a first buffer portion BFP_31, a second buffer portion BFP_32, a third buffer portion BFP_33, and a fourth buffer portion BFP_34. The second buffer portion BFP_32 may form an angle of about 180° with the first buffer portion BFP_31 with respect to the columnar portion COL. The third buffer portion BFP_33 may form an angle of about 90° with the first buffer portion BFP_31 and with the second buffer portion BFP_32 with respect to the columnar portion COL. The fourth buffer portion BFP_34 may form an angle of about 180° with the third buffer portion BFP_33 with respect to the columnar portion COL. The fourth buffer portion BFP_34 may form an angle of about 90° with the first buffer portion BFP_31 and with the second buffer portion BFP_32 with respect to the columnar portion COL.

Although not illustrated, the first, second, third, and fourth buffer portions BFP_31, BFP_32, BFP_33, and BFP_34 may have downwardly convex curved shapes similar to the buffer portions BFP1 and BFP2 illustrated in FIG. 4.

FIG. 13 is a view illustrating a configuration of a support portion of a display device according to an exemplary embodiment of the present inventive concept.

FIG. 13 illustrates a cross-sectional view corresponding to FIG. 9. Hereinafter, a configuration of a support portion SUP_4 will be described mainly with regard to differences from the configurations of the support portion SUP illustrated in FIG. 4. Further, the same configuration as the support portion SUP is illustrated by using the same reference signs, and a description of the same configuration may be omitted.

Referring to FIG. 13, the support portion SUP_4 may include a columnar portion COL_1, a plurality of buffer portions BFP_41 and BFP_42, a subsupport portion S_SUP, an insertion portion IP, and a coupling portion CP. The columnar portion COL_1 may extend in the third direction DR3 to be disposed under the diffusion plate DFP. An upper end of the columnar portion COL_1 may be in contact with the diffusion plate DFP, and a lower end of the columnar portion COL_1 may be spaced apart from a bottom portion BP of a first accommodating portion BS.

The buffer portions BFP_41 and BFP_42 may be connected to predetermined portions of the columnar portion COL_1 adjacent to the lower end of the columnar portion COL_1. The buffer portions BFP_41 and BFP_42 may have downwardly convex curved shapes extending away from the columnar portion COL_1.

The subsupport portion S_SUP may be connected to a lower end of a first buffer portion BFP_41 of the buffer portions BFP_41 and BFP_42. The subsupport portion S_SUP may have a size larger than a size of a first hole H1 and a size of a second hole H2. The subsupport portion S_SUP may be disposed on a reflective sheet RS around the second hole H2. For example, outer edge portions of the subsupport portion S_SUP are disposed on the reflective sheet RS and a central portion of the subsupport portion S_SUP overlaps the first and second holes H1 and H2.

The insertion portion IP may be connected to a lower portion of the subsupport portion S_SUP to be inserted into the first and second holes H1 and H2. The coupling portion CP may be connected to a lower portion of the insertion portion IP. A configuration of the coupling portion CP may be the same as the coupling portion CP illustrated in FIG. 4. When an external impact is applied to a diffusion plate DFP, a second buffer portion BFP_42 included in the buffer portions BFP_41 and BFP_42 may absorb the external impact while being moved horizontally.

In an exemplary embodiment of the present inventive concept, support portions for supporting a diffusion plate by being connected to a first accommodating portion may absorb an impact applied to the diffusion plate. Thus, a display device according to an exemplary embodiment of the present inventive concept may prevent damage to the diffusion plate due to an external impact.

While the present inventive concept has been particularly shown and described with reference to exemplary embodiments thereof, it will be apparent to those of ordinary skill in the art that various changes in form and detail may be made thereto without departing from the spirit and scope of the present inventive concept.

What is claimed is:

1. A display device comprising:
a display panel extending along a first direction and a second direction crossing the first direction;
a diffusion plate disposed under the display panel;
a light source disposed under the diffusion plate;
a first accommodating portion, wherein the light source and the diffusion plate are each disposed on the first accommodating portion; and
a support portion coupled to the first accommodating portion to support the diffusion plate,
wherein the support portion comprises:
a columnar portion extending in a third direction perpendicular to the first and second directions;
a coupling portion connected to a lower end of the columnar portion and coupled to the first accommodating portion; and
a plurality of buffer portions connected to portions of the columnar portion and having a convex curved shape protruding downward, wherein the portions of the columnar portion are disposed between an upper end of the columnar portion and the lower end of the columnar portion.

2. The display device of claim 1, wherein the lower end of the columnar portion is inserted into a first hole provided in the first accommodating portion.

3. The display device of claim 2, wherein the coupling portion passes through the first hole to be disposed under the first accommodating portion around the first hole.

4. The display device of claim 3, wherein the coupling portion includes at least two hooks extending in different directions from each other.

5. The display device of claim 2, wherein the coupling portion includes:
a vertical extending portion connected to the lower end of the columnar portion and extending in the third direction; and
a plurality of hooks extending from a lower end of the vertical extending portion,
wherein each of the plurality of hooks forms an angle smaller than about 90° with the vertical extending portion and extends upward, and upper ends of the plurality of hooks are disposed under the first accommodating portion around the first hole.

6. The display device of claim 2, wherein the light source includes:
a plurality of light source substrates disposed on a plurality of grooves provided in the first accommodating portion; and
a plurality of light source units respectively mounted on the plurality of light source substrates.

7. The display device of claim 6, further comprising a plurality of first holes including the first hole, and a plurality of support portions including the support portion, wherein the plurality of first holes and the plurality of support portions are disposed between pairs of light source substrates of the plurality of light source substrates.

8. The display device of claim 6, further comprising a reflective sheet disposed on the plurality of light source substrates and having insertion holes provided therein, the insertion holes having the plurality of light source units inserted thereinto,
wherein the lower end of the columnar portion is inserted into a second hole provided in the reflective sheet such that the second hole overlays the fast hole.

9. The display device of claim 8, wherein the coupling portion passes through the second hole and the first hole and is disposed under the first accommodating portion.

10. The display device of claim 8, wherein the upper end of the columnar portion is in contact with the diffusion plate, and lower ends of the plurality of buffer portions are in contact with the reflective sheet.

11. The display device of claim 1, wherein the plurality of buffer portions are closer to the lower end of the columnar portion than to the upper end of the columnar portion.

12. The display device of claim 1, wherein the columnar portion, the coupling portion, and the plurality of buffer portions are formed together as a single body.

13. The display device of claim 1, wherein the support portion comprises a plastic material having a predetermined elasticity.

14. The display device of claim 1, further comprising an optical sheet disposed between the display panel and the diffusion plate.

15. The display device of claim 1, wherein the plurality of buffer portions comprise:
a first buffer portion; and
a second buffer portion forming an angle of 180° with the first buffer portion with respect to the columnar portion and having a shape symmetrical to that of the first buffer portion with respect to the columnar portion.

16. The display device of claim 1, wherein the plurality of buffer portions comprise:
a first buffer portion;
a second buffer portion forming an angle of about 120° with the first buffer portion with respect to the columnar portion; and
a third buffer portion forming an angle of about 120° with each of the first buffer portion and the second buffer portion with respect to the columnar portion.

17. The display device of claim 1, wherein the plurality of buffer portions comprise:
a first buffer portion;
a second buffer portion forming an angle of about 180° with the first buffer portion with respect to the columnar portion;
a third buffer portion forming an angle of about 90° with the first buffer portion with respect to the columnar portion; and
a fourth buffer portion forming an angle of about 1800 with the third buffer portion with respect to the columnar portion.

18. A display device comprising:
a display panel extending in a first direction and a second direction crossing the first direction;
a diffusion plate disposed under the display panel;
a light source disposed under the diffusion plate;
a first accommodating portion, wherein the light source and the diffusion plate are disposed on the first accommodating portion; and
a support portion coupled to the first accommodating portion to support the diffusion plate,
wherein the support portion comprises:
a columnar portion extending in a third direction perpendicular to the first and second directions;
a coupling portion connected to a lower end of the columnar portion and coupled to the first accommodating portion; and
a plurality of buffer portions connected to portions of the columnar portion, wherein the portions of the columnar portion are disposed between an upper end of the columnar portion and the lower end of the columnar portion, and
wherein each of the plurality of buffer portions forms an angle smaller than about 90° with the columnar portion, extends downward, and is substantially straight.

19. A display device comprising:
a display panel;
a diffusion plate disposed under the display panel;
a light source disposed under the diffusion plate;
a first accommodating portion, wherein the light source and the diffusion plate are disposed on the first accommodating portion; and
a support portion coupled to the first accommodating portion to support the diffusion plate,
wherein the support portion comprises:
a columnar portion extending in a direction crossing the display panel;
a plurality of buffer portions connected to portions of the columnar portion and having a convex curved shape protruding downward, wherein the portions of the columnar portion are adjacent to a lower end of the columnar portion;
a subsupport portion connected to a lower end of a first buffer portion of the plurality of buffer portions;
an insertion portion connected to a lower portion of the subsupport portion and inserted into a first hole provided in the first accommodating portion; and
a coupling portion connected to a lower portion of the insertion portion and disposed on a lower portion of the first accommodating portion around the first hole.

20. The display device of claim 19, wherein the subsupport portion is larger than the first hole,
an upper end of the columnar portion is in contact with the diffusion plate, and
the lower end of the columnar portion is spaced apart from a bottom portion of the first accommodating portion.
